(19) United States
(12) Patent Application Publication
(10) Pub. No.: US 2013/0339160 A1
(43) Pub. Date: Dec. 19, 2013

(54) APPLICATION MARKETPLACE FOR ONLINE ADVERTISING APPLICATIONS

(71) Applicant: AppNexus Inc., New York, NY (US)

(72) Inventors: Jon Avery, New York, NY (US); Travis Johnson, Brooklyn, NY (US)

(73) Assignee: AppNexus Inc., New York, NY (US)

(21) Appl. No.: 13/907,578

(22) Filed: May 31, 2013

Related U.S. Application Data
(60) Provisional application No. 61/654,058, filed on May 31, 2012.

(51) Int. Cl. G06Q 30/02

(52) U.S. Cl. CPC G06Q 30/0277
USPC 705/14.73

(57) ABSTRACT

A method of managing access to advertising configuration objects in an online advertising platform includes defining a set of application programming interface (API) services. Each API service performs actions with respect to one or more of the advertising configuration objects, each of which has one or more configuration fields. Permissions associated with individual users of the online advertising platform are received, with each permission indicating an ability of a respective user to interact with one of the advertising configuration objects via one of the API services. Interaction is facilitated between users and an application that communicates with and provides field-specific instructions to the online advertising platform via the API services. The ability of the application to cause execution of the field-specific instructions is based on the permissions associated with the particular user interacting with the application. A system for implementing the method is also provided.

### CROSS-REFERENCE TO RELATED APPLICATION

This application claims priority to, and the benefit of, U.S. Provisional Patent Application No. 61/654,058, filed May 31, 2012, and entitled “Application Marketplace for Online Advertising Applications,” the entirety of which is incorporated by reference herein.

### TECHNICAL FIELD

The invention relates generally to an online application platform, and more specifically to an online application platform having a permissioned application programming interface and third-party authentication functionality.

### BACKGROUND INFORMATION

One of the major challenges within the online advertising market is the massive fragmentation of companies, services, and technology providers. A significant lack of standards among the mix of technologies and disparate user interfaces and backend systems makes integration between parties difficult, if not impossible.

More and more, the buying and selling of online or world wide web display advertising is moving from a “bulk impression” model to a “user specific” buying model where specific advertising is generated for a specific user or impression consumer. Agencies, networks, and publishers are getting smarter about which specific users are valuable for a given campaign; advertisers now require more and more flexible buying mechanisms to reach those specific users. Today's mechanisms require bulk purchasing based on some coarse targeting parameters. Current attempts at deeper integration between user data and the impression buyer generally involve some level of HTTP redirects which bounce a user back and forth between various serving systems. This makes the process very slow, adversely affects an impression consumer's experience of a website, and has a negative impact on the effectiveness of advertising included in a website.

Accordingly, there is a need for a modernized online advertising platform that incorporates managed sales and real-time auctions for advertising space inventory. Further, because such a platform may benefit from interoperability with third-party applications and may require substantial exchanges of potentially confidential information regarding advertising strategy, there arises a need for an applications platform that integrates with the advertising platform and addresses these needs.

### SUMMARY OF THE INVENTION

As described in various embodiments herein, the invention provides an application integration framework for an online advertisement serving platform (“OASP”) that allows for interaction between the user interface of the application and the OASP while the application is displayed to user as an iframe element on a web page. The invention further provides a method and system for applying OASP user permissions to an application such that the application may be limited in its interaction with the OASP through an application programming interface. Further, the invention structures the presentation and communication of applications in “flavors,” such that the categorical behavior of an application with respect to the OASP can be more easily defined in development.

In one aspect, a method of managing access to advertising configuration objects in an online advertising platform includes defining a set of application programming interface services. Each application programming interface service performs actions with respect to one or more of the advertising configuration objects, each of which has one or more configuration fields. Permissions associated with individual users of the online advertising platform are received, with each permission indicating an ability of a respective user to interact with one of the advertising configuration objects via one of the application programming interface services. Interaction is facilitated between users and an application that communicates with and provides field-specific instructions to the online advertising platform via the application programming interface services. The ability of the application to cause execution of the field-specific instructions is based on the permissions associated with the particular user interacting with the application.

In one embodiment, at least one of the received permissions indicates an ability of a user to perform actions with respect to configurations field of one of the configuration objects. These actions may be read actions, modify actions, create actions, and/or delete actions.

In another embodiment, at least one of the received permissions indicates an ability of a user to use one of the application programming services. The configuration fields of at least one of the configuration objects may include an advertising campaign budget field, a bidding strategy field, and/or a profile targeting field.

In yet another embodiment, the method further includes providing the application with permissions equivalent to the permissions associated with the user interacting with the application.

In another aspect, a system for managing access to advertising configuration objects in an online advertising platform includes an interface module for defining application programming interface services. The application programming interface services are used for performing actions with respect to the advertising configuration objects, each of which has one or more configuration fields. Permissions associated with individual users of the online advertising platform are received via a permissions module, with each permission indicating an ability of a respective user to interact with one of the advertising configuration objects via one of the application programming interface services. An application platform module facilitates interaction between users and an application that communicates with and provides field-specific instructions to the online advertising platform via the application programming interface services. The ability of the application to cause execution of the field-specific instructions is based on the permissions associated with the user interacting with the application.

In one embodiment, at least one of the permissions received via the permissions module indicates an ability of a user to perform actions with respect to configuration fields of one of the configuration objects. These actions may be read actions, modify actions, create actions, and/or delete actions.

In another embodiment, at least one of the permissions received via the permissions module indicates an ability of a user to use one of the application programming services. The configuration fields of at least one of the configuration objects may include an advertising campaign budget field, a bidding strategy field, and/or a profile targeting field.

In yet another embodiment, the application platform module is further for providing the application with permissions equivalent to the permissions associated with the user interacting with the application.

Other aspects and advantages of the invention will become apparent from the following drawings, detailed description, and claims, all of which illustrate the principles of the invention, by way of example only.

### BRIEF DESCRIPTION OF THE DRAWINGS

A more complete appreciation of the invention and many attendant advantages thereof will be readily obtained as the same becomes better understood by reference to the following detailed description when considered in connection with the accompanying drawings. In the drawings, like reference characters generally refer to the same parts throughout the different views. Further, the drawings are not necessarily to scale, with emphasis instead generally being placed upon illustrating the principles of the invention.

FIG. 1A is an exemplary diagram illustrating interactions between an application and an advertisement serving platform according to an embodiment of the invention.

FIG. 1B is an exemplary diagram illustrating interactions between an application and a platform user interface according to an embodiment of the invention.

FIG. 2 is an exemplary user interface for viewing permissions according to an embodiment of the invention.

### DETAILED DESCRIPTION

Various embodiments of the invention provide an online applications (“Apps”) platform that allows developers to create and use custom applications that interface with an OASP, such as the AppNexus® platform, by AppNexus Inc. of New York, N.Y., described in U.S. patent application Ser. No. 13/049,579, filed on Mar. 16, 2011, and entitled “Advertising Venues and Optimization,” the entirety of which is hereby incorporated by reference. Generally, the Apps platform includes a set of application programming interfaces (“APIs”) that, among other functions, facilitates the creation and use of applications and tools for manipulating and understanding data, tailoring the functionality of an advertising campaign workflow, providing customized reporting views, and engaging in other activities related to the OASP.

### App Integration Framework

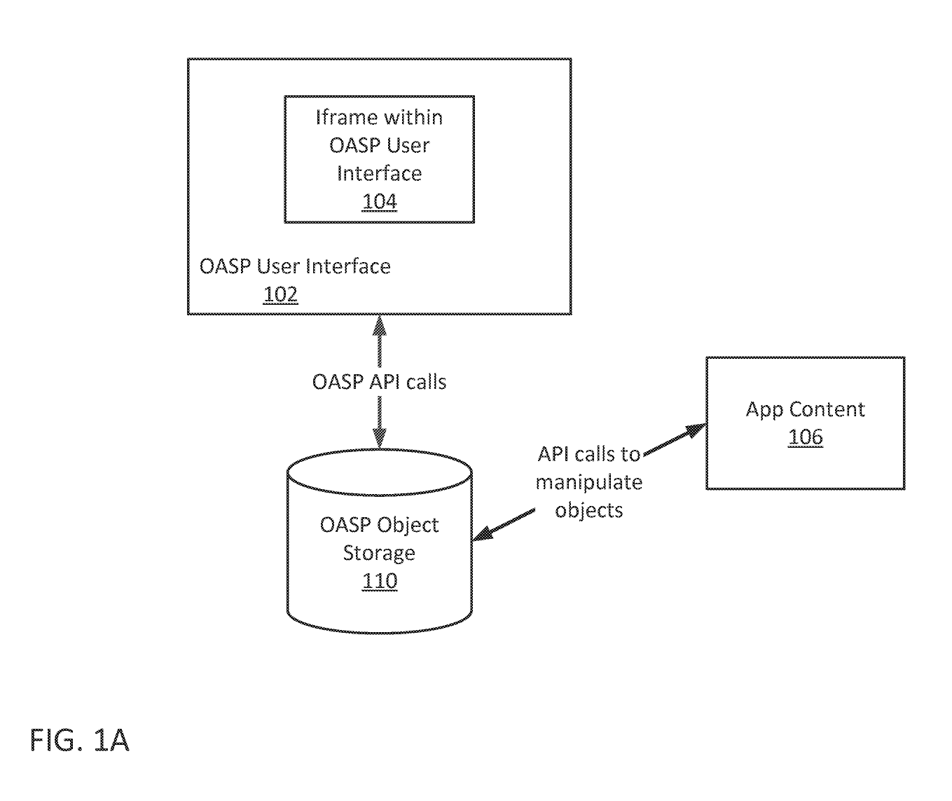

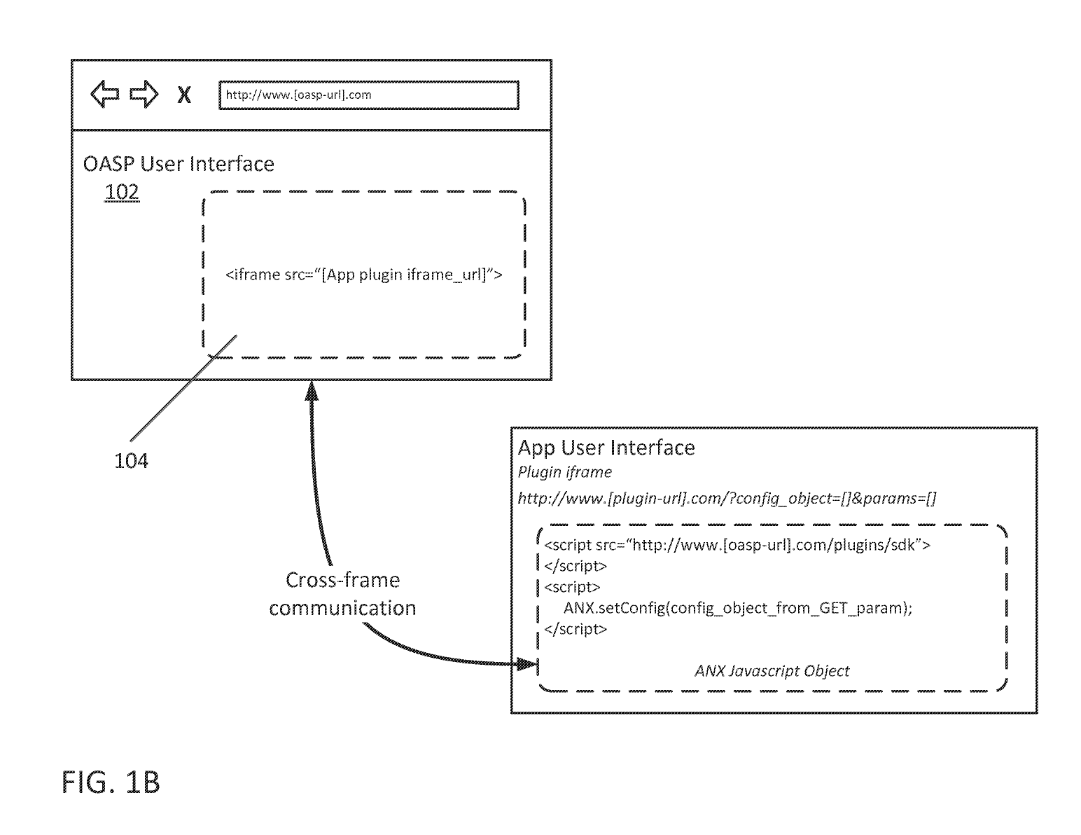

Referring to the exemplary embodiment illustrated in FIG. 1A, Apps include two integration points with an OASP user: the user interface (“UI”) 102 and the API set. In this implementation, Apps are constructed as iframe browser elements 104 which are loaded into various parts of an OASP UI 102 for use by the App developer or for provisioning to an OASP customer. The URL of the iframe 104 is provided and hosted by the developer, and the developer controls the content 106 and functionality of the App. In other embodiments, however, the App content 106 may be hosted by the provider of the Apps platform. An App user that has an OASP account may be identified to the App via parameters that are passed to the iframe 104. The OASP and App UI 102 communicate through the use of a software development kit (SDK) associated with the OASP, thereby allowing the App to make API calls on behalf of the App user's account. The App may make API calls indirectly through the App UI 102, thereby allowing the App to manipulate objects stored on the OASP storage 110.

The integration of Apps into the OASP UI 102 may be a multistage process. In one embodiment, an App registers with the OASP and provides the following pieces of information:
a) an App URL,
b) a name, contact, and other metadata to display to users when they use or view the App's details (e.g., for API support),
c) an openSSL public key, and
d) any API permissions required by the App.
   It should be noted that in some circumstances, additional or alternative parameters may be provided to integrate Apps into the OASP UI 102. For example, in some embodiments, each App is associated with a “developer” entity that is associated with the OASP. To register the App, the developer entity information may be provided to the OASP. This information may be provided automatically if an App member or user has an associated developer.

Following registration, an instance of the App is created. In this case, “instance” refers to an instantiation of the App in the UI 102, as well as an HTML document hosted by the App developer. Creation of the instance may entail creating an iframe 104 pointing to the App's URL, with some or all of the following URL parameters passed to the App (a loading bar may be shown until the App responds):
a) configs: configuration details for cross-domain communication,
b) uid: an ID unique to that specific instance of the launched App,
c) sdk_url: the URL pointing to the OASP SDK code included in the App's HTML (for establishing communication between the App and the OASP UI 102),
d) extra: any extra data from the OASP UI 102, which depends on context (for API support),
e) api_url: the URL to the OASP API, and
f) user_id_token: a token that the App passes to the API to retrieve the user_id.
   Once the URL parameters are received, the App instance: ensures that sdk_url and api_url are from an OASP domain, thereby preventing man-in-the-middle attacks; includes <script src={sdk_url}></script> into the webpage document, creating a JavaScript object called “ANX”); and enables the “ANX” object by passing it configuration data (e.g., ANX.setConfig({[object passed as GET param]}).

Following the above steps, cross-domain communication may be established between the OASP UI 102 and the App instance, thus facilitating communication in a manner which appears seamless to the user. In essence, the App instance can respond to OASP UI events, and the OASP UI 102 can respond to App instance events and instructions.

FIG. 1B illustrates one example of cross-communication between the OASP UI 102 and an App hosted on a separate domain. In this example, the App user is shown that App loading is complete by having the App instance send a message to the OASP UI 102 indicating that it has been successfully loaded. In response, the OASP UI 102 removes the loading bar and displays the loaded App instance within the iframe 104. In some embodiments, if the App fails to send the loading complete message to the OASP within a fixed time period, it is assumed that the App failed to load, and the user may be shown a formatted error message.

In another example, the App instance serves as a form input. When the user of the OASP UI 102 indicates that content should be saved (e.g., by clicking a “Save” button), the UI 102 sends a message to the App requesting values, and enters a “loading” state. The App receives the request for values, and returns to the OASP UI 102 a JSON representation of its values. Subsequently, the UI 102 receives the values and continues with form submission. This process allows Apps to set values in the OASP without having to make backend API calls, and notably, allows Apps to be directly inserted into the OASP workflow. In other words, users are permitted to set values that are provided in the OASP UI 102, as well as set certain values via the Apps.

Cross-domain communication also enables accessing data from the OASP UI 102 upon initialization. When the App is loaded, it is passed relevant information in the “extra” URL parameter, such as which items are selected on the OASP UI 102 page. For example, the OASP may supply the App with an advertiser identifier so that the App is aware of which advertiser will be using the App.

The OASP UI 102 also uses cross-domain communication to respond to App instance events and requests. The App instance may, for example, request that it be resized, hidden, shown, closed, and the like. Due to iframe browser restrictions, the App may be unable to directly change its container DOM properties. Therefore, to change its size, the App sends a message to the OASP UI 102 indicating a requested size, and the OASP UI 102 is responsible for resizing the App.

Once an App and the OASP UI 102—are in communication, the platform may allow for the integration of third-party functionality directly into the OASP UI 102. In one example, an OASP user logs into the OASP, and an authentication token allows the user to be granted access to a third-party site. One authenticated, the user is able to access the third-party functionality within the OASP UI 102. Further, the third party can interact with the OASP via the user's OASP account to manipulate OASP objects such as ad campaign targeting, embed pixels or scripts (client-executable code) into an existing advertising creative, feed third-party bid optimization data to the OASP, or any number of other functions.

### API Access and Permissions

Apps can be given permission to manipulate objects in the OASP on behalf of a user who has installed and launched the App. For example, an App may pull reporting data or modify advertising campaign parameters. One option for developing an App is one that does not manipulate options on the OASP, but that allows the user to interact with content hosted solely on the App developer's domain. For example, an App may allow an OASP user to build third-party contextual and behavioral data via a data provider's system, which will then be manually applied to the OASP by the OASP user.

If the App is designed to provide additional OASP-based functionality, the App can be granted permission to take various actions with respect to the OASP API within the App user's OASP account. API permissioning gives App users greater confidence in installing and using Apps within the OASP. By providing limited access to API services, users need not worry that an App will modify data that it should not have access to, or steal any data that it does not need for operation. For instance, if an App is only used to add pixels to a creative, there would not be any need for the App to have access to an API service used by ad publishers. A user would not need to worry that the App would accidentally delete a publisher or misappropriate a client list of publishers.

Further, ad serving platforms involve large monetary transactions, and there may be serious financial consequences if an App malfunctions, is poorly designed, or is run by a “bad actor”—similar to an App that operates within a stock trading platform. Because of this, the permissioning processes may be designed in such a manner that they are highly restrictive and facilitate a high degree of control over preventing unintended mistakes or intended bad behavior, while still allowing for complex business relationships and workflow integrations among multiple (often three or more) parties that may have competing interests.

This is especially true in the online advertising environment where media buyers, media sellers, and vendors all work with each other and may also directly compete with each other. For example, many App developers are in some ways in competition with their App users because the App developer and/or the App user may act as a media buyer and/or media seller. Moreover, many technology vendors (e.g., computer companies, game companies, etc.) often also have media buying and selling businesses to sell their technologies to advertisers and publishers. Because online advertising (and especially online advertising auctioning) is a relatively new industry, the roles and relationships of the various companies overlap more so than in more established industries where the business models and strategies are more clearly defined. Thus, App users are reluctant to allow the App to access certain proprietary information such as campaign budgets (be it for a particular creative, time period and/or publisher), placement preferences, and other campaign targeting information. The users may also pay closer attention to what permissions an App should have in order to prevent data leakage, which may be less of a concern in a system where the App developers are unlikely to be competitors.

In some embodiments, Apps use the same OASP API that the OASP UI 102 uses. An App may make API calls while authenticated as an OASP user, and therefore can retrieve and manipulate that user's objects, possibly including their creatives, campaigns, campaign targeting (profiles), and user segments, which reside in the OASP database. In some of these instances, OASP API access may require Apps to obtain authentication tokens. Once a token is obtained, it is included in all subsequent OASP API calls, allowing the App to make calls on behalf of a given OASP user. As such, the permissions of the App are limited based on the App user's permissions. In some instances, the App's permissions may include all of the user's permissions, or, in other cases, a subset of the user's permissions.

In one embodiment, the API is permissioned in a manner that limits the types of access that different users have to the functions associated with API services. For example, the permissioning may be done at the service level, or, in some cases, at the field level. In cases where API permissions have been provided, users view/accept the permissions when installing Apps. Before the App can make API calls on behalf of a user, the user's parent member installs the App, thereby allowing the user access to it. Before the user decides to install an App, the user views the permissions the App will be given to make API calls on the user's behalf once the App is installed.

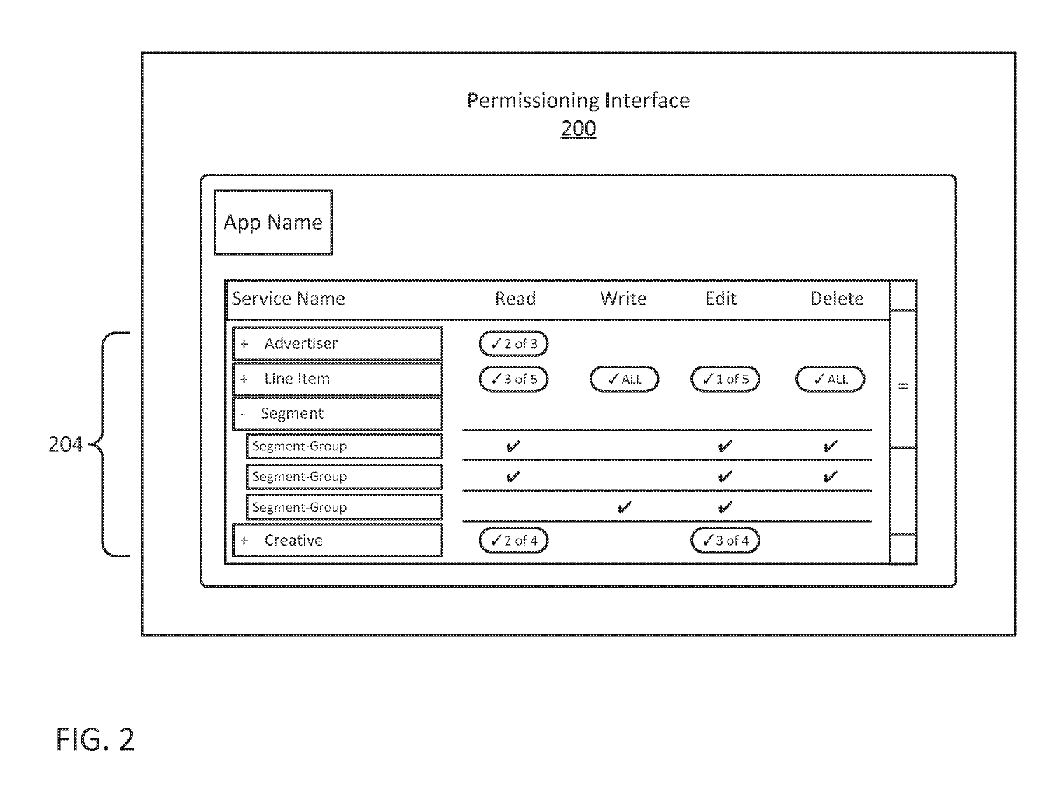

FIG. 2 illustrates an exemplary graphical user interface 200 for viewing field permissions. A user is provided with a list of API services 204, each of which may expand to show a list of individual fields accessible through the respective API service. As depicted, the Segment Service expands to allow permissions to be set for the individual fields of “Segment-Group,” “Segment-Group-Target”, and “Segment-Sub-Group.” The possible permissions for each service/field include “Read,” “Write,” “Edit,” and “Delete,” further described below.

In some embodiments, Apps do not have permissions to any OASP API services by default. Instead, App permissions are set by OASP administrators on a case-by-case basis. An App may have a static set of permissions that is the same for every user, which are then further restricted based on an individual user's permission set. Users can then decide whether or not to install an App based on the set of permissions the App has, as well as other factors such as the identity of the App developer, and the App's functionality. In other embodiments, App permissions are requested by App developers, which may or may not be granted by OASP administrators or by an automated system that evaluates the needs of the Apps and allows permissions as appropriate. In yet other embodiments, App developers are given direct access to set permissions on Apps.

More specifically, the App framework allows permissioning on a subset of fields within a particular service. In one embodiment, the OASP API is a REST API that has numerous services, each with the ability to manipulate a certain category of objects. Each service has associated with it a number of fields, which may include fields such as name, ID, and other parameters that are either informational or that affect an OASP user's account behavior. With field-level permissions, the access that each App has can be restricted down to the field level within each service. Field level permissions may apply to one, some or every field in the OASP API. Further, entire services may be permissioned, as well as each API method (GET, PUT, POST, and DELETE). For example, an App may have permission to read all fields of a service but only write to two of them.

For example, a user may want to enable an App to change segment targeting on a user's campaign. The App developer wants to allow the user to select an existing campaign by name within the App, so the App can be given access to reading the “name” field on a Campaign Service API and not have access to any other information accessible through this API service, which could include potentially sensitive budget and timeframe information. Then the campaign's targeting is defined by the “profile” object associated with the campaign, and the App can be given a read/write limitation on certain segment-related fields on the profile object, but not to any other targeting parameters, such as which ad inventory is targeted. Two major benefits of this approach are: 1) it avoids passing sensitive information such as targeting strategies to the App hoster and/or developer, and 2) it prevents the App hoster and/or developer from invoking unwanted processes with an OASP user's account. Moreover, there is no need to create separate services for each aspect of the campaign targeting process, which would be necessary if the App's permissioning was not done at the field level.

With respect to permissioning entire API services, the API permissions may be represented as a set of rules of the following format: <service_name>: <methods_allowed>. In one embodiment, there are at least four types of permissions for each service and field:

| Permission | Description |
|---|---|
| GET | read service objects |
| POST | create (write) service objects |
| PUT | edit service objects |
| DELETE | delete service objects |

Example API service permissions of an App might be campaign service: GET, PUT, POST; segment service: GET; line-item service: GET, PUT, POST, DELETE. In a more user-friendly format, service permissions may be represented as in the table below.

| | Read | Write | Edit | Delete |
|---|---|---|---|---|
| Campaign Service | X | X | X | |
| Segment Service | X | | | |
| Line-Item Service | X | X | X | X |

As indicated above, the OASP API may include various services that interact with categories of objects in the OASP. It should be noted, however, that not all services may be required for successful operation of an OASP. In some implementations, more, fewer, or different services may be used to access different categories of objects having a variety of data fields.

In one implementation, one set of services deals with members and users (e.g., a Member Service and a User Service). Members are generally clients or partners who have a financial relationship and/or contract with the OASP and who, in some circumstances, use the OASP UI. For example, an ad network that buys and sells media through the OASP UI may be considered a member. A member has a single OASP account and one set of data in the OASP UI. A member may have many individual users, and each user may have his own login to the OASP UI and the OASP API. In some cases, if an individual user installs an App, that App will be installed for that member and all of that member's users. Likewise, if the App makes any changes to a campaign setup or anything else in the member's account, that change will exist for the member as a whole.

API access is granted to individual users within a member. With respect to the User Service, a “user” refers to people or groups able to log in to the OASP UI and API. Users are classified by a user_type, which determines the type of information they have access to. The User Services allows member-level users to create other users, as well as modify and retrieve information about existing users. An exemplary list of user types according to one embodiment is described in the table below.

| User Type | Description |
|---|---|
| Member | Regular network user. May see all data for a |
| | member's account. |
| Advertiser | Very limited user with access to one advertiser |
| | (mainly for reporting). |
| Publisher | Very limited user with access to one publisher |
| | (mainly for reporting). |
| member_advertiser | May have no API access. May use the OASP |
| | UI to manage a list of advertisers. |
| member_publisher | May have no API access. May use the OASP |
| | UI to manage a list of publishers. |

Maintaining different user types in the OASP offers a number of advantages. As one example, it allows for the implementation of publisher or advertiser dashboards. In such an embodiment, the OASP UI defines publisher or advertiser logins, which allows users to view a subset of the advertisers or publishers that belong to an OASP member. An App developer may then provide limited content to these advertiser and publisher logins, such that the content does not include information or functionality for anything else in the OASP other than these advertisers or publishers. One common use case for an advertiser or publisher login App is a reporting dashboard that shows performance or trends for a particular advertiser or publisher. Again, it is important to note that the App makes API calls on behalf of the OASP user (in this case reporting calls) as well as incorporating its own App functionality.

The API calls described above can be used to manipulate User objects via the User Service. For example:

| | API | | Additional |
|---|---|---|---|
| Action | Call | Exemplary URL String Parameter | Parameters |
| Add a new user | POST | http://[API DOMAIN]/user | JSON structure |
| | | | of new user data |
| Modify an existing user | PUT | http://[API DOMAIN]/user?id=user_id | JSON structure |
| | | | of modified user |
| | | | data |
| View all users associated | GET | http:// [API DOMAIN]/user | |
| with a member | | | |
| View a specific user | GET | http:// [API DOMAIN]/user?id=user_id | |
| View the current user | GET | http:// [API DOMAIN]/user?current | |

As described above, each OASP user may have permissions to read, modify, create, and/or delete objects (or the individual fields within the objects) managed by the OASP. Once a user logs into an App, these permissions translate to the App, giving it equivalent (or in some cases more limited) permissions as the user. A user with write access to a particular User object may therefore access that User object through an App, and modify fields in the object via the User Service in the OASP API. For example, the user (and App) may have permission to modify the “email” field of a user, thereby updating the user's email address as stored by the OASP.

In one implementation, API permissioning allows OASP users and Apps to be restricted in how they can access, modify, or perform other operations on configuration fields through services such as the Member Service (described above). For example, in addition to interacting with standard fields such as member name and ID, more significant fields can be manipulated, such as those involving resale of managed impression inventory, segment and other data sharing among OASP members, member credit limit, and sources of trusted inventory.

In other embodiments, API permissions can be set with respect to fields within Profile objects, or to API operations using the Profile Service itself. Generally, Profile objects contain a set of targeting parameters, such as gender, age, geography, and frequency. Access to the targeting parameters may be finely tuned as necessary for each OASP user and/or App. Further, Profile objects may be assigned to and used in conjunction with various objects in the OASP.

API permissioning becomes particularly important when an App provides instructions that implicate services and fields which, when altered, have significant financial or strategic consequences. For example, the Campaign Service provides a means for working with Campaign objects, which are sets of fields that define the configuration of an advertising campaign. Apps with the required permissions are able to read or modify campaign budgeting and bidding strategy fields such as the exemplary fields shown in the tables below. As the modification of these fields can have substantial effects on the operation of an advertiser's campaign and as a result the cost of the campaign, the App is granted write permissions to these fields only when absolutely necessary. The more granular the permissioning process can be, the more useful the App will be to the user, and the less concerned the user will be that certain settings will be inadvertently modified or data unintentionally exposed.

Pricing and Budgeting Fields

| Field | Type | escription |
|---|---|---|
| lifetime_budget | Double | The lifetime budget for the campaign |
| | | (in dollars). |
| lifetime_budget_imps | Int | The lifetime limit of the number of |
| | | impressions for the campaign. |
| daily_budget | Double | The daily budget for the campaign |
| | | (in dollars). |
| daily_budget_imps | Int | The daily limit of the number of |
| | | impressions for the campaign. |
| learn_budget | Double | The amount of the budget allocated |
| | | to learning. |

Bidding Strategy Fields

| Field | Type | Description |
|---|---|---|
| cpm_bid_type | enum | Possible values: “base”, “average”,“clearing”, |
| | | “predicted”, or “margin”. Average is equivalent |
| | | to Estimated Average Price (EAP); clearing is |
| | | equivalent to Estimated Clear Price (ECP); |
| | | predicted means you set a CPC goal (cpc_goal) |
| | | or CPA goal. |
| base_bid | double | A CPM bid. May be modified by a cadence |
| | | modifier. |
| min_bid | double | Minimum bid that will apply to variable pricing |
| | | models. |
| max_bid | double | Maximum bid that will apply to variable pricing |
| | | models. |

### App Flavors

In some instances, Apps have multiple “flavors.” An App flavor refers to where the App appears in the OASP UI workflow. It may also refer to the “communication protocol,” or the methods and events that are allowed for that type of App, the events it can respond to, the format of the responses, and how the App communicates with the OASP UI. In other words, the interactions allowed between an App instances and the OASP UI may be dictated depending on the App's flavor. In some embodiments, the developer of the App selects the flavor based on the desired behavior for the App. If, for example, the App's interaction is tied directly to a creative, the developer may select the Creative Action flavor (described below) for the App. Each type of flavor may appear in the console UI or other portions or components of the OASP UI. Available App flavors include, but are not limited to:

1) Standalone: This type of App instance is opened and takes up a large portion of the OASP UI. There is no communication protocol; rather, the App resides in an iframe through which the App developer provides content. However, standalone Apps are able to make OASP API calls on behalf of the user, similar to other types of flavors.

2) Dialog: This type of abstract App instance is opened in a dialog. The App selects the dimensions of the dialog and can request that the OASP UI close the dialog at any time. Additionally, when the user clicks “close” on the dialog, the App instance is notified and can replace the close with a confirmation-to-close message.

3) Creative Action: This type of App instance is a subtype of the dialog flavor. When the App is installed, it appears in a “more actions” menu on the OASP UI. When launched, the IDs and names of creatives that are selected in the OASP UI are passed to the App. For example, this information may be passed to the App through the extras parameter formed as an array or creatives in the URL string: http://[APPDOMAIN]/app?extra[creatives][0][id]=1234&extra[creatives][1][id]=5678. This allows the App to pre-populate certain information (e.g., the creatives the user wants to work with) in the App. A Creative Action flavor App may also be available in other portions of the OASP UI, such as a campaign or publisher manager interface.

4) Segment Chooser: This type of App instance is displayed within a form. Upon the user hitting “save” the form enters a “waiting” state, and the App instance is queried to retrieve values. The App instance returns values in a specified format, and, upon receiving the values, the OASP UI submits the form along with the App instance's values. Further, when the form is loaded for editing, the App instance is notified of what values are currently set, and populates itself accordingly. This type of App may be used when saving data for campaigns, which include various types of targeting such behavioral and contextual data (e.g., cookies, groups of URLs, etc.). This data is organized in “segments.” The Segment Chooser flavor is designed such that data segment providers can develop an App that facilitates setting data segments on a campaign.

5) Render Callback: Rather than rendering this type of flavor in an iframe, the App developer gives the OASP UI a “render method” for the App. The OASP UI is then responsible for drawing the content on the webpage. In some implementations, the render method involves HTML code defining how the App appears, and a script file (e.g., written in JavaScript) that instructs the UI how to manipulate the displayed HTML. For example, the HTML may list the name of a campaign, and the script provides an overlay of recent spend data for a campaign when that campaign value is selected or moused-over.

The algorithms, processes, and techniques described in the various embodiments herein may be implemented and performed by a computer including a processing unit, a system memory, and a system bus that couples various system components including the system memory to the processing unit. The algorithms, processes, and techniques may be described in the general context of computer-executable instructions, such as program modules stored on computer-readable media, being executed by such a computer.

For example, the OASP, Apps platform, and various modules and components that make up the foregoing may be implemented as software executing on a computer, or as integrated circuitry (e.g., an FPGA or other microchip). One skilled in the art will recognize the various forms in which the platforms may be implemented. If implemented as software, the platforms may execute on a system capable of running a commercial operating system such as the Microsoft Windows® operating systems, the Apple OS X® operating systems, the Apple iOS® platform, the Google Android™ platform, the Linux® operating system and other variants of UNIX® operating systems, and the like.

The platforms may operate in a client-server environment, with one or more servers responsible for operating the components of the OASP and Apps platform, and one or more client computers interacting with platforms implemented on the servers. The OASP or the Apps platform may include an interface module that defines the API services for interacting with advertising configuration objects and the fields contained therein. The platforms may further include a permissions module that facilitates the specification of OASP user and/or App API permissions for performing actions on the configuration objects and fields. In addition, the platforms may include an application platform module for facilitating the various interactions between OASP users and Apps as described throughout this disclosure.

The software may be implemented on such hardware as a smart or dumb terminal, network computer, personal digital assistant, wireless device, smartphone, game machine, music player, mobile telephone, laptop, palmtop, wireless telephone, information appliance, workstation, minicomputer, mainframe computer, or other computing device, that is operated as a general purpose computer or a special purpose hardware device that can operate the OASP and/or Apps platform. The software may be implemented on a general purpose computing device in the form of a computer including a processing unit, a system memory, and a system bus that couples various system components including the system memory to the processing unit.

The software may be in the form of a standalone application, implemented in a multi-platform language/framework such as Java, .Net, Objective C, or in native processor executable code. Any suitable programming language may be used in accordance with the various embodiments of the invention. Illustratively, a programming language used may include assembly language, Ada, APL, Basic, C, C++, C#, Objective C, COBOL, dBase, Forth, FORTRAN, Java, Modula-2, Pascal, Prolog, REXX, and/or JavaScript, for example. Further, it is not necessary that a single type of instruction or programming language be utilized in conjunction with the operation of the system and method of the invention. Rather, any number of different programming languages may be utilized as is necessary or desirable.

In various embodiments, the client computers include a web browser, client software, or both. The web browser allows the client to request a web page or other downloadable program, applet, or document (e.g., from the server(s)) with a web page request. One example of a web page is a data file that includes computer executable or interpretable information, graphics, sound, text, and/or video, that can be displayed, executed, played, processed, streamed, and/or stored and that can contain links, or pointers, to other web pages. In one embodiment, a user of the client manually requests a web page from the server. Alternatively, the client automatically makes requests with the web browser. Examples of commercially available web browser software are Microsoft® Internet Explorer®, Mozilla® Firefox®, and Apple® Safari®.

In some embodiments, the client computers include client software. The client software provides functionality to the client that allows a user to interact with the OASP and Apps platform. The client software may be implemented in various forms, for example, it may be in the form of a web page, widget, and/or Java, JavaScript, .Net, Silverlight, Flash, and/or other applet or plug-in that is downloaded to the client and runs in conjunction with the web browser. The client software and the web browser may be part of a single client-server interface; for example, the client software can be implemented as a “plug-in” to the web browser or to another framework or operating system. Any other suitable client software architecture, including but not limited to widget frameworks and applet technology may also be employed with the client software. The client software may also be in the form of a standalone application, implemented in a multi-platform language/framework as described above.

A communications network may connect the clients with the servers. The communication may take place via any media such as standard telephone lines, LAN or WAN links (e.g., T1, T3, 56 kb, X.25), broadband connections (ISDN, Frame Relay, ATM), wireless links (802.11, Bluetooth, GSM, CDMA, etc.), and so on. The network may carry TCP/IP protocol communications, and HTTP/HTTPS requests made by a web browser, and the connection between the clients and servers can be communicated over such TCP/IP networks. The type of network is not a limitation, however, and any suitable network may be used. Non-limiting examples of networks that can serve as or be part of the communications network include a wireless or wired Ethernet-based intranet, a local or wide-area network (LAN or WAN), and/or the global communications network known as the Internet, which may accommodate many different communications media and protocols. When used in a LAN networking environment, computers may be connected to the LAN through a network interface or adapter. When used in a WAN networking environment, computers typically include a modem or other communication mechanism. Modems may be internal or external, and may be connected to the system bus via the user-input interface, to the network via wireless or wired Ethernet, or other appropriate mechanism. Computers may be connected over the Internet, an Intranet, Extranet, Ethernet, or any other system that provides communications. Some suitable communications protocols may include TCP/IP, UDP, or OSI for example. For wireless communications, communications protocols may include Bluetooth, Zigbee, IrDa or other suitable protocol. Furthermore, components of the system may communicate through a combination of wired or wireless paths.

In a client-server environment, the servers may be implemented on one or more server class computers that have sufficient memory, data storage, and processing power and that run a server class operating system (e.g., Oracle® Solaris®, GNU/Linux®, and the Microsoft® Windows® family of operating systems). Other types of system hardware and software than that described herein may also be used, depending on the capacity of the device and the number of users and the size of the user base. For example, each server may be or may be part of a logical group of one or more servers such as a server farm or server network. As another example, there may be multiple servers associated or connected with each other, or multiple servers that operate independently, but use shared data. In a further embodiment and as is typical in large-scale systems, application software may be implemented in components, with different components running on different server computers, on the same server, or some combination. Those skilled in the art will appreciate that the invention may be practiced with various computer system configurations, including hand-held wireless devices such as mobile phones or personal digital assistants (PDAs), multiprocessor systems, microprocessor-based or programmable consumer electronics, minicomputers, mainframe computers, and the like.

The invention may also be practiced in distributed computing environments where tasks are performed by remote processing devices that are linked through a communications network. In a distributed computing environment, program modules may be located in both local and remote computer storage media including memory storage devices.

In some cases, relational (or other structured) databases may provide such functionality, for example as a database management system which stores data related to the services and consumers utilizing the service. Examples of databases include the MySQL® Database Server, the Oracle® Database Server, the PostgreSQL Database Server, or the IBM® DB2® Database Server.

Computers typically include a variety of computer readable media that can form part of the system memory and be read by the processing unit. By way of example, and not limitation, computer readable media may comprise computer storage media and communication media. The memory for the computer systems described herein may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by processing unit. The data or program modules may include an operating system, application programs, other program modules, and program data. As mentioned, the operating system may be or include a variety of operating systems such as a Microsoft® Windows® operating system (e.g., Windows 7), an Apple® Macintosh® operating system (e.g., OS X), a UNIX operating system, a GNU/Linux( )R operating system, the Xenix operating system, the IBM AIX™ operating system, the Hewlett Packard UX™ operating system, the Novell Netware™ operating system, the Oracle Solaris® operating system, the IBM OS/2™ operating system, or another operating system or platform.

At a minimum, the memory includes at least one set of instructions that is either permanently or temporarily stored. The processor executes the instructions that are stored in order to process data. The set of instructions may include various instructions that perform a particular task or tasks. Such a set of instructions for performing a particular task may be characterized as a program, software program, software, engine, module, component, mechanism, or tool.

The described systems may include a plurality of software processing modules stored in a memory as described above and executed on a processor in the manner described herein. The program modules may be in the form of any suitable programming language, which is converted to machine language or object code to allow the processor or processors to read the instructions. That is, written lines of programming code or source code, in a particular programming language, may be converted to machine language using a compiler, assembler, or interpreter. The machine language may be binary coded machine instructions specific to a particular computer.

Also, the instructions and/or data used in the practice of the invention may utilize any compression or encryption technique or algorithm, as may be desired. An encryption module might be used to encrypt data. Further, files or other data may be decrypted using a suitable decryption module.

The computing environment may also include other removable/non-removable, volatile/nonvolatile computer storage media. For example, a hard disk drive may read or write to non-removable, nonvolatile magnetic media. A magnetic disk drive may read from or writes to a removable, nonvolatile magnetic disk, and an optical disk drive may read from or write to a removable, nonvolatile optical disk such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media are typically connected to the system bus through a removable or non-removable memory interface.

The processing unit that executes commands and instructions may be a general purpose computer, but may utilize any of a wide variety of other technologies including a special purpose computer, a microcomputer, mini-computer, mainframe computer, programmed micro-processor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID integrated circuits, smart chip, or any other device or arrangement of devices that is capable of implementing the steps of the processes of the invention.

It should be appreciated that the processors and/or memories of the computer system need not be physically in the same location. Each of the processors and each of the memories used by the computer system may be in geographically distinct locations and be connected so as to communicate with each other in any suitable manner. Additionally, it should be appreciated that each of the processor and/or memory may be composed of different physical pieces of equipment.

A user may enter commands and information into the computer through a user interface that includes input devices such as a keyboard and pointing device, commonly referred to as a mouse, trackball or touch pad. Other input devices may include a microphone, joystick, game pad, satellite dish, scanner, voice recognition device, keyboard, touch screen, toggle switch, pushbutton, or the like. These and other input devices are often connected to the processing unit through a user input interface that is coupled to the system bus, but may be connected by other interface and bus structures, such as a parallel port, game port or a universal serial bus (USB).

One or more monitors or display devices may also be connected to the system bus via an interface. In addition to display devices, computers may also include other peripheral output devices, which may be connected through an output peripheral interface. The computers implementing the invention may operate in a networked environment using logical connections to one or more remote computers, the remote computers typically including many or all of the elements described above.

Although internal components of the computer are not shown, those of ordinary skill in the art will appreciate that such components and the interconnections are well known. Accordingly, additional details concerning the internal construction of the computers need not be disclosed in connection with the present invention.

Certain embodiments of the present invention are described above. It is, however, expressly noted that the present invention is not limited to those embodiments, but rather the intention is that additions and modifications to what is expressly described herein are also included within the scope of the invention. Moreover, it is to be understood that the features of the various embodiments described herein are not mutually exclusive and can exist in various combinations and permutations, even if such combinations or permutations are not made express herein, without departing from the spirit and scope of the invention. In fact, variations, modifications, and other implementations of what is described herein will occur to those of ordinary skill in the art without departing from the spirit and the scope of the invention. As such, the invention is not to be defined only by the preceding illustrative description, but rather by the claims.

What is claimed is:

1. A method, implemented on at least one computer, of managing access to advertising configuration objects in an online advertising platform, the at least one computer comprising:
at least one memory storing computer-executable instructions; and
at least one processing unit for executing the instructions stored in the memory, wherein execution of the instructions results in the at least one computer performing the steps of:
defining a plurality of application programming interface services, each service for performing actions with respect to one or more of the advertising configuration objects, each configuration object having one or more configuration fields;
receiving permissions associated with individual users of the online advertising platform, each permission indicating an ability of a respective user to interact with one of the advertising configuration objects via one of the application programming interface services; and
facilitating interaction between at least one of the users and an application, the application being in communication with and providing field-specific instructions to the online advertising platform via the application programming interface services, wherein an ability of the application to cause execution of the field-specific instructions is based on the permissions associated with the user interacting with the application.

2. The method of claim 1, wherein at least one of the received permissions indicates an ability of a user to perform actions with respect to at least one configuration field of one of the configuration objects.

3. The method of claim 2, wherein the actions are selected from the group consisting of read actions, modify actions, create actions, and delete actions.

4. The method of claim 1, wherein at least one of the received permissions indicates an ability of a user to use one of the application programming services.

5. The method of claim 1, wherein the configuration fields of at least one of the configuration objects comprise an advertising campaign budget field.

6. The method of claim 1, wherein the configuration fields of at least one of the configuration objects comprise a bidding strategy field.

7. The method of claim 1, wherein the configuration fields of at least one of the configuration objects comprise a profile targeting field.

8. The method of claim 1, further comprising providing the application with permissions equivalent to the permissions associated with the user interacting with the application.

9. A system for managing access to advertising configuration objects in an online advertising platform, the system comprising:
at least one memory storing computer-executable instructions; and
at least one processing unit for executing the instructions stored in the memory, wherein execution of the instructions results in one or more application modules together comprising:
an interface module for defining a plurality of application programming interface services, each service for performing actions with respect to one or more of the advertising configuration objects, each configuration object having one or more configuration fields;
a permissions module for receiving permissions associated with individual users of the online advertising platform, each permission indicating an ability of a respective user to interact with one of the advertising configuration objects via one of the application programming interface services; and
an application platform module for facilitating interaction between at least one of the users and an application, the application being in communication with and providing field-specific instructions to the online advertising platform via the application programming interface services, wherein an ability of the application to cause execution of the field-specific instructions is based on the permissions associated with the user interacting with the application.

10. The system of claim 9, at least one of the received permissions indicates an ability of a user to perform actions with respect to at least one configuration field of one of the configuration objects.

11. The system of claim 10, wherein the actions are selected from the group consisting of read actions, modify actions, create actions, and delete actions.

12. The method of claim 9, wherein at least one of the received permissions indicates an ability of a user to use one of the application programming services.

13. The system of claim 9, wherein the configuration fields of at least one of the configuration objects comprise an advertising campaign budget field.

14. The system of claim 9, wherein the configuration fields of at least one of the configuration objects comprise a bidding strategy field.

15. The system of claim 9, wherein the configuration fields of at least one of the configuration objects comprise a profile targeting field.

16. The method of claim 9, wherein the application platform module is further for providing the application with permissions equivalent to the permissions associated with the user interacting with the application.
